(19) United States
(12) Patent Application Publication
(10) Pub. No.: US 2025/0203445 A1
(43) Pub. Date: Jun. 19, 2025

(54) REAL-TIME RADIO ACCESS NETWORK CELL CONGESTION INDICATOR

(71) Applicant: T-MOBILE INNOVATIONS LLC, Overland Park, KS (US)

(72) Inventors: Zheng Fang, Mclean, VA (US); Yu Wang, Fairfax, VA (US)

(21) Appl. No.: 18/541,677

(22) Filed: Dec. 15, 2023

(51) Int. Cl. H04W 28/02; H04L 5/00

(52) U.S. Cl. CPC H04W 28/0268; H04L 5/0053; H04W 28/0284

(57) ABSTRACT

Systems and methods for modifying quality of service (QoS) flow for devices having particular device types based on cell congestion are provided. It is determined that a congestion level of a cell associated with a node exceeds a predetermined threshold, where the cell is providing communication to at least a first device having a first device type and a second device having a second device type. Prior to transmitting a packet to a component of a wireless communications network, a header associated with the packet is modified to include an indication that the congestion level of the cell exceeds the predetermined threshold. Based on the indication that the congestion level of the cell exceeds the predetermined threshold, a QoS flow is modified for devices having the first device type but not for devices having the second device type.

### SUMMARY

This summary is provided to introduce a selection of concepts in a simplified form that are further described below in the detailed description. This summary is not intended to identify key features or essential features of the claimed subject matter, nor is it intended to be used in isolation as an aid in determining the scope of the claimed subject matter.

According to various aspects of the technology, Quality of Service (QoS) flow from a core network component to a node (eNodeB, gNodeB, satellite node) may be modified or regulated based on an indication received that the node or a cell of that node is congested. While typically congestion information is only received sporadically at the core network, aspects herein provide for a more efficient and effective way for the core network to know about cell congestion. For instance, in aspects, packet headers may be modified to include, from the node, an indication of congestion. This indication may be a percentage, or may just be an “ON” or “OFF” indicating that congestion is above or below a threshold. This provides a near real-time indication, so that QoS flow for certain devices can be regulated.

### BRIEF DESCRIPTION OF THE DRAWINGS

Aspects of the present disclosure are described in detail herein with reference to the attached Figures, which are intended to be exemplary and non-limiting, wherein:

FIG. 1 is a diagram illustrating an example network environment for use in accordance with aspects herein;

FIG. 2 is flow chart illustrating a method for modifying QoS flow for devices having particular device types based on cell congestion, in accordance with aspects herein;

FIG. 3 is flow chart illustrating another method for modifying QoS flow for devices having particular device types based on cell congestion, in accordance with aspects herein;

FIG. 4 is flow chart illustrating another method for modifying QoS flow for devices having particular device types based on cell congestion, in accordance with aspects herein; and

FIG. 5 is a diagram illustrating an example computing environment, in accordance with some aspects.

### DETAILED DESCRIPTION

In the following Detailed Description, reference is made to the accompanying drawings that form a part hereof, and in which is shown by way of specific illustrative aspects in which the aspects may be practiced. These aspects are described in sufficient detail to enable those skilled in the art to practice the aspects, and it is to be understood that other aspects may be utilized and that logical, mechanical and electrical changes may be made without departing from the scope of the present disclosure. The following detailed description is, therefore, not to be taken in a limiting sense.

One or more aspects of the present disclosure provide for, among other things, solutions that address the challenges associated with fixed wireless access (FWA) devices that may arise, as FWA devices typically consume a large percentage of spectrum (e.g., 5G spectrum in a 5G network). For example, a typical FWA device may consume as much as ten times the amount of resources as a typical user device (e.g., smartphone). Because of this, capacity/congestion concerns may arise at nodes. In order to conserve network resources and to ensure that appropriate resources are available for all device types, aspects herein facilitate the management of network resources by, for example, regulating QoS flow from the core network to cells of nodes that are congested. While typically, the core network does not know of such cell congestion until well after the congestion occurs, aspects herein allow for the core network to receive an indication of cell congestion in near real-time. For example, when packets are sent from nodes to the core network (e.g., requesting data from the Internet), the packet itself (e.g., the header of the packet) may indicate whether a cell at that node is congested. If the packet indicates congestion, the core network may utilize a date packet inspecting (DPI) engine to regulate QoS flow in the downlink direction for certain devices types. This regulation of QoS flow may include reducing data speeds in the downlink direction, queuing/throttling acknowledgment (ACK) messages/responses from the core network to the node, etc. There are some devices types that are lower priority than others, meaning they may not require as high of data speeds in the uplink and/or downlink directions as other device types. As such, in one aspect, FWA devices may receive regulated QoS flow to help with managing network resources.

An FWA device may comprise an access device (e.g., a network access device) that shares connectivity services available through a wireless base station with one or more UE that are in communication with the FWA device. An FWA device is intended to provide high speed broadband home internet services to a customer premises and is therefore typically deployed to a customer premises location that falls within a local cellular base station coverage area for a mid-band or high-band radio frequency (RF) layer (e.g., the 5G NR N41 frequency band) that can provide high bandwidth/high speed connections (e.g., 190-200 MHz bandwidth channels) within a radius of several miles from a cell tower. A node may also provide a coverage area for a low-band RF band layer (e.g., the 5G NR N71 frequency band) that may provide a lower speed connection (e.g., 1-15 MHz bandwidth channels) than a mid-band or high-band RF band layer, but may provide that coverage over a comparably substantially more expansive area (e.g., on the order of hundreds of square miles).

As used herein, a “node” (also referenced herein as an access point or base station) is one or more transmitters or receivers or a combination of transmitters and receivers, including the accessory equipment, necessary at one location for providing a service involving the transmission, emission, and/or reception of radio waves for one or more specific telecommunication purposes to a mobile station (e.g., a UE or device). The term/abbreviation UE (also referenced herein as a user device, device, or wireless communications device (WCD)) can include any device employed by an end-user to communicate with a telecommunications network, such as a wireless telecommunications network. A device can include a mobile device, a mobile broadband adapter, or any other communications device employed to communicate with the wireless telecommunications network. A device, as one of ordinary skill in the art may appreciate, generally includes one or more antennas coupled to a radio for exchanging (e.g., transmitting and receiving) transmissions with a nearby access point.

As used herein, a device (also referenced herein as a user equipment (UE) or a wireless communication device) can include any device employed by an end-user to communicate with a wireless telecommunications network. A device can include a mobile device, a mobile broadband adapter, a fixed location or temporarily fixed location device, or any other communications device employed to communicate with the wireless telecommunications network. For an illustrative example, a device can include cell phones, smartphones, tablets, laptops, small cell network devices (such as micro cell, pico cell, femto cell, or similar devices), and so forth. Further, a device can include a sensor or set of sensors coupled with any other communications device employed to communicate with the wireless telecommunications network; such as, but not limited to, a camera, a weather sensor (such as a rain gage, pressure sensor, thermometer, hygrometer, and so on), a motion detector, or any other sensor or combination of sensors. A device, as one of ordinary skill in the art may appreciate, generally includes one or more antennas coupled to a radio for exchanging (e.g., transmitting and receiving) transmissions with a nearby access point or access point.

In one aspect, a system for modifying QoS flow for devices having particular device types based on cell congestion is provided. The system includes one or more processors and one or more computer-readable media storing computer-usable instructions that, when executed by the one or more processors, cause the one or more processors to perform a method. The method includes receiving congestion level information associated with a node by way of a header associated with a packet communicated from the node. The congestion level information includes an indication that a congestion level of a cell associated with the node exceeds a predetermined threshold. Further, based on the congestion level information, the method includes modifying a QoS flow for devices of a first device type but not for devices of a second device type.

In another aspect, a method is provided for modifying QoS flow for devices having particular device types based on cell congestion. The method includes determining that a congestion level of a cell associated with a node exceeds a predetermined threshold. The cell is providing communication to at least a first device having a first device type and a second device having a second device type. The method also includes, prior to transmitting a packet to a component of a wireless communications network, modifying a header associated with the packet to include an indication that the congestion level of the cell exceeds the predetermined threshold. Further, the method includes, based on the indication that the congestion level of the cell exceeds the predetermined threshold, modifying a quality of service (QoS) flow for devices having the first device type but not for devices having the second device type.

In yet another aspect, a method is provided for modifying QoS flow for devices having particular device types based on cell congestion. The method includes determining that a congestion level of a cell associated with a node exceeds a predetermined threshold. The cell is providing communication to at least a first device having a first device type and a second device having a second device type. Further, the method includes, concurrent with a communication of packets from the node, communicating congestion level information for the cell to a component of a wireless communications network. The congestion level information indicates that a congestion level of the cell is above a predetermined threshold. Also, the method includes, based on the indication that the congestion level of the cell exceeds the predetermined threshold, receiving communications from the component of the wireless communications network in accordance with a modified QoS flow for the first device having the first device type but not for the second device having the second device type.

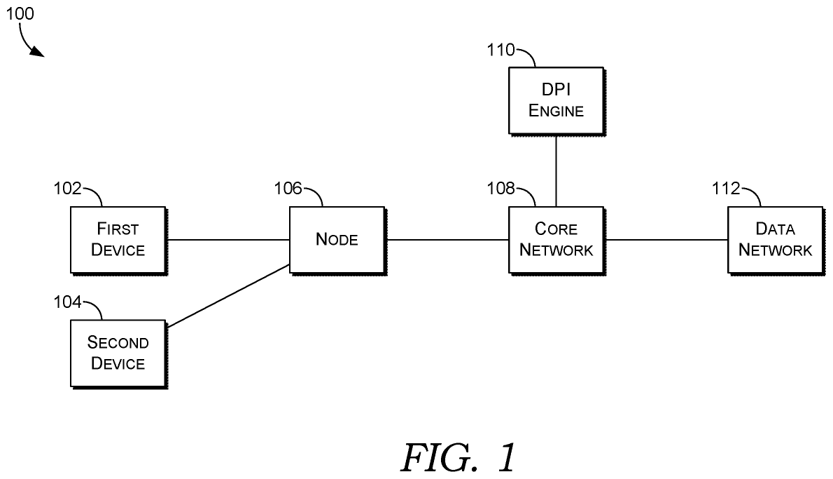

FIG. 1 is a diagram illustrating an example network environment 100 embodiment in which aspects of regulating RAN cell loading may be implemented. Network environment 100 is but one example of a suitable network environment and is not intended to suggest any limitation as to the scope of use or functionality of the embodiments disclosed herein. Neither should the network environment 100 be interpreted as having any dependency or requirement relating to any one or combination of components illustrated.

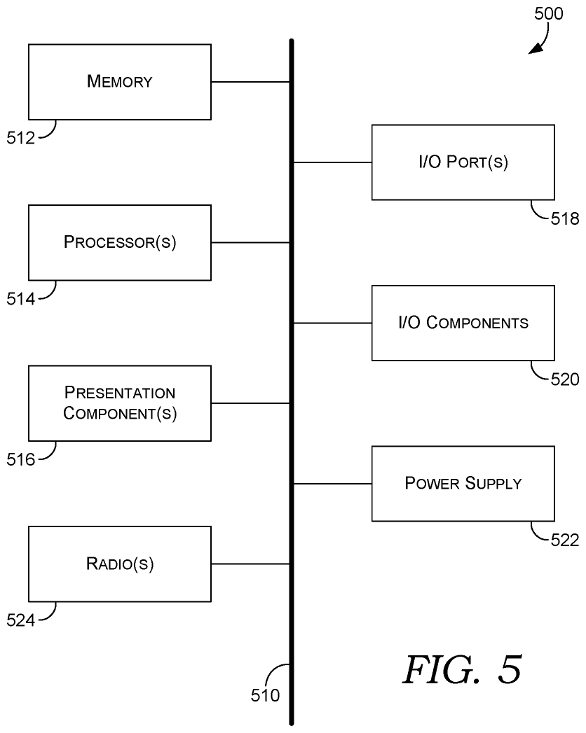

As shown in FIG. 1, network environment 100 comprises first device 102, second device 104, node 106, core network 108, deep packet inspection (DPI) engine 110, and data network 112. Devices 102 and 104 may in general, comprise forms of equipment and machines such as but, not limited to, Internet-of-Things (IoT) devices and smart appliances, autonomous or semi-autonomous vehicles including cars, trucks, trains, aircraft, urban air mobility (UAM) vehicles and/or drones, industrial machinery, robotic devices, exoskeletons, manufacturing tooling, thermostats, locks, smart speakers, lighting devices, smart receptacles, controllers, mechanical actuators, remote sensors, weather or other environmental sensors, wireless beacons, cash registers, turnstiles, security gates, or any other smart device. That said, in some embodiments, devices 102 and 104 may include computing devices such as, but not limited to, handheld personal computing devices, cellular phones, smart phones, tablets, laptops, and similar consumer equipment, or stationary desktop computing devices, workstations, servers and/or network infrastructure equipment. As such, devices 102 and 104 may include both mobile UE and stationary UE devices. Devices 102 and 104 can include one or more processors, and one or more non-transient computer-readable media for executing code to carry out the functions of devices 102 and 104 described herein. The computer-readable media may include computer-readable instructions executable by the one or more processors. In some embodiments, devices 102 and 104 may be implemented using a computing device 500 as discussed below with respect to FIG. 5.

Nodes, such as node 106, are often individually referred to as a radio access network (RAN) and/or a wireless communication base station system. In the embodiment shown in FIG. 1, node 106 may function as an access node via which the devices 102 and 104 within coverage area of the node 106 can wirelessly access services of the core network 108, such as telecommunications and data connectivity. In the context of fourth generation (4G) Long Term Evolution (LTE), node 106 may be referred to as an eNodeB, or eNB. In the context of fifth generation (5G) New Radio (NR), a node 106 may be referred to as a gNodeB, or gNB. Nodes may be terrestrial or extraterrestrial. Other terminology may also be used depending on the specific implementation technology. As such, in some embodiments network environment 100 comprises, at least in part, a wireless communications network, such as core network 108, which communicates with DPI engine 110 and data network (e.g., Internet, private network) 112.

In some embodiments, node 106 may comprise a multi-modal network (for example comprising one or more multi-modal access devices) where multiple radios supporting different systems are integrated into the radio of node 106. Such a multi-modal RAN may support a combination of 3GPP radio technologies (e.g., 4G, 5G and/or 6G) and/or non-3GPP radio technologies.

Core network 108 may be a component of a wireless communications network that provides one or more wireless network services to one or more devices (e.g., devices 102 and 104) within the coverage areas of a plurality of nodes, including node 106. In particular, core network 108 provides combinations of network services to devices 102 and 104 for at least one public land mobile network (PLMN) which devices 102 and 104 may attach to via channels of one or more RF bands (referred to herein as RF band layers).

The network environment 100 is generally configured for wirelessly connecting devices 102 and 104 to other devices via node 106, via other RAN and/or other local wireless cellular access points, and/or via other telecommunication networks or a publicly-switched telecommunication network (PSTN), for example. The operating environment 100 may be generally configured, in some embodiments, for wirelessly connecting devices 102 and 104 to data or services that may be accessible on one or more application servers or other functions, nodes, or servers (such as services provided by servers of a data network (DN) 112, for example). DN 112, in aspects, may be a private data network, or a public data network (e.g., the Internet).

DPI engine 110 may receive instructions from core network 108 to begin regulating QoS flow to/from node 106, or a particular cell of node 106. For example, modifying the QoS flow may comprise modifying the downlink-centric TCP application, or putting the corresponding TCP uplink ACK packet into a delay queue to postpone these ACK messages to slow down the download speed, but not drop these ACK messages completely to avoid unnecessary UE re-transmit ACK messages in the uplink direction. Generally DPI relates to analyzing network traffic, and may also extract protocol- and application-based metadata, providing insight into user behavior and application usage. Here, the DPI works alongside and/or may be a component of the core network 108.

Generally, devices 102 and 104 communicating with node 106 by way of SIB, which is one example of a 5G air interface. System Information Block (SIB) plays a crucial role in the 5G air interface, acting as an informational bridge between devices and the gNB. Specifically, SIBs serve as broadcasted messages that provide essential network information to user devices, ensuring efficient communication and seamless connectivity. In the context of the 5G air interface, SIBs convey details such as cell configuration, radio resource management parameters, and mobility management information. These blocks are periodically broadcasted by the gNB, enabling user devices to access, interpret, and adapt to the dynamic conditions of the 5G network. SIBs contribute to the establishment and maintenance of a robust and responsive air interface, facilitating optimal performance and enhancing the overall user experience in the rapidly evolving landscape of 5G communications.

A GPRS Tunneling Protocol (GTP) tunnel is a virtual communication path established between two network entities in a mobile communication network. Here, a GTP tunnel may exist between node 106 and core network 108. A GTP tunnel facilitates the transmission of user data or signaling messages between these entities, typically across the core network. GTP tunnels are widely used in many networks (e.g., LTE, 4G, 5G) and play a crucial role in ensuring efficient communication and mobility management. There are two main types of GRP headers, including GTP-U (user plane) headers and GTP-C (control plane) headers. GTP-U headers encapsulate user data packets, allowing them to be transported across the GPRS backbone or the core network, while GTP-C headers are responsible for signaling messages between network nodes to manage mobility, session establishment, and other control plane functions.

In one aspect herein, if a serving cell of node 106 on the uplink radio resource is exceeding a configured threshold for congestion, the node 106 may set/add a GTP-U uplink congestion bit to “ON” inside the enhanced PDU session container header extension. Additionally or alternatively, if a serving cell of node 106 on the downlink radio resource is falling above a configured threshold, node 106 may set the GTP-U downlink congestion bit to “ON.” When the corresponding GTP-U congestion bit is “ON,” the core network 108 may instruct DPI engine 110 to initiate the regulation of the QoS flow. For example, when QoS flow is to be regulated for downlink-centric TCP application, the core network 108 may put the corresponding TCP uplink ACK packets into a delay queue to postpone/delay these ACK messages to slow down the download speed, but it wouldn't drop these ACK messages completely to avoid unnecessary re-transmit by the devices 102 and 104 of ACK messages on the uplink direction. 3GPP TS 38.415 is a standard that describes extensions that may be utilized for aspects described herein. For example, there may be extension header fields that are currently unused and may be reserved that may be utilized to indicate cell congestion.

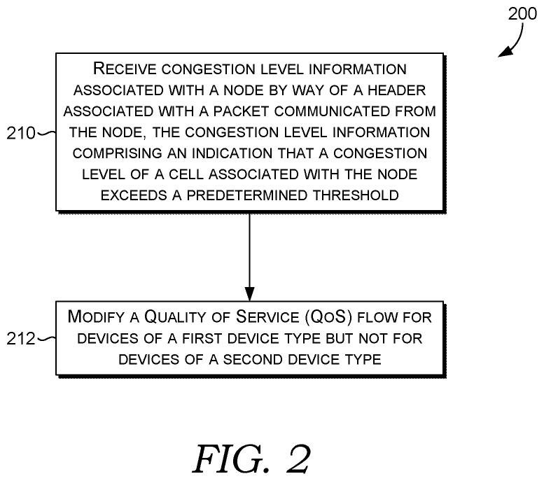

FIG. 2 is a flow chart illustrating an example method 200 for modifying quality of service (QoS) flow for devices having particular device types based on cell congestion, according to an aspect herein. Initially at block 210, congestion level information associated with a node is received by way of a header of a packet communicated from the node. The congestion level information may include an indication that a congestion level of a cell associated with the node exceeds a predetermined threshold. In some instances, the congestion level information may include a percentage of congestion of the cell, which would be a more precise way of indicating congestion than just “ON” or “OFF.” In other instances, a “0” or “1” may be used to indicate congestion. Congestion level, in some aspects, may be a throughput or a load of a particular cell or a node. Further, congestion may have occurred in either the uplink, downlink, or both. If congestion is indicated in either uplink or downlink, the QoS flow in the downlink may be modified, in some aspects herein. In some instances, the node may be indiating cell congestion in the uplink direction, but this uplink congestion could be used to indicate downlink congestion as well. In other words, it is likely that if there is uplink congestion, there may also be downlink congestion. The core network, such as a DPI engine within the core network, may look for a congestion indication before unpacking the packet, thus the notification of congestion to the core network is near instantaneous, or in near real-time and simultaneous or concurrent to the receipt of packets at the core network.

When QoS flow is modified, downlink speed of data sent from a component of the wireless communications network to the node may be reduced. As previously mentioned, there are many ways of modifying QoS flow, including simply decreasing the downlink speed of data to the node, which in turn decreases the speed of data to the device, or delaying/queuing ACK messages to the node from the core network.

At block 212, a QoS flow is modified for devices of a first device type for not for devices of a second device type. In one aspect, the first device type is a FWA device, wherein the modified QoS flow affects the FWA device(s) but not the other device types. As previously mentioned, FWA devices typically use radio frequencies to provide broadband internet access to homes and businesses without the need for physical cables. The impact on network resources can vary based on many factors, but many times FWA devices consume much larger amounts of spectrum resources than non-FWA devices. As more FWA devices are added to networks, there becomes a stronger need to manage network resources overall, and specifically for FWA devices. In some instances, FWA devices may be considered “low priority” devices with respect to user devices, such as cell phones. The goal is to ensure FWA devices receive the necessary resources and priority without adversely impacting the overall network or degrading services for other devices. For these reasons, QoS flow may be regulated for FWA devices, but not for other device types.

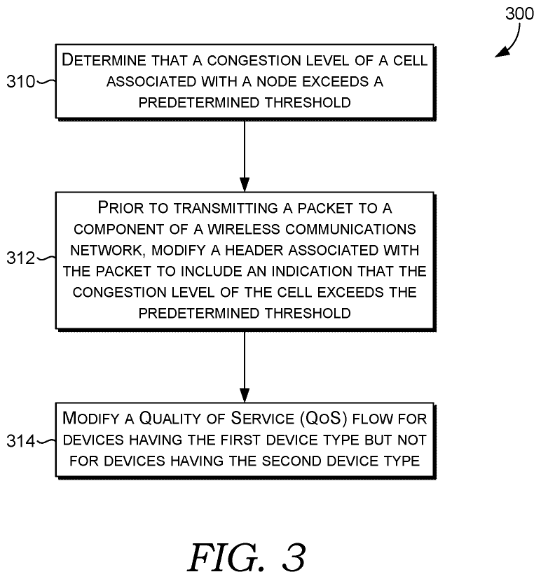

Turning now to FIG. 3, another method 300 is provided for modifying QoS flow for devices having particular device types based on cell congestion. At block 310, it is determined that a congestion level of a cell associated with a node exceeds a predetermined threshold. The cell provides communication to at least a first device having a first device type and a second device having a second device type. In reality, there may be many more than two device types relying on a cell for communication. In aspects, the congestion level may be in the uplink direction, downlink direction, or both.

At block 312, prior to transmitting a packet to a component of a wireless communciations network, a header associated with the packet is modified to include an indication that the congestion level of the cell exceeds the predetermined threshold. For example, in one aspect, two new IEs may be added to a GTP-U session container extension header. The first may be for downlink cell loading status and the second may be for uplink cell loading status (e.g., 5G NR Cell Identity (NCI) 36-bit plus loading congestion condition bit (ON/OFF). For instance, if a serving cell of node on the uplink radio resource is exceeding a configured threshold for congestion, the node may set/add a GTP-U uplink congestion bit to “ON” inside the enhanced PDU session container header extension. Additionally or alternatively, if a serving cell of node on the downlink radio resource is falling above a configured threshold, node may set the GTP-U downlink congestion bit to “ON.” When the corresponding GTP-U congestion bit is “ON,” the core network may instruct DPI engine to initiate the regulation of the QoS flow.

At block 314, a QoS flow for devices of the first device type but not for devices of the second device type is modified, and may be based on the indication that the congestion level of the cell exceeds the predetermined threshold. In aspects, the QoS flow may comprise a downlink speed of data sent from a component of the wireless communications network (e.g., the core network) to the node. Further, as mentioned previously, the first device type may be a FWA device, such that the modification of QoS flow may be to reduce the speed of data flow back to the cell or node for the FWA devices. Or, modifying QoS flow may include throttling fulfillment of a data request from the devices having the first device type (e.g., FWA devices). Here, the throttling may include queuing TCP uplink ACK messages.

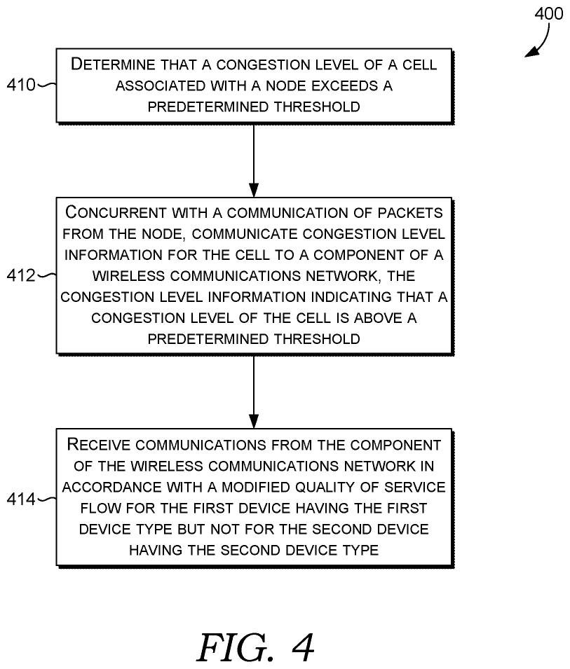

Referring to FIG. 4, another method 400 is provided for modifying QoS flow for devices having particular device types based on cell congestion. At block 410, it is determined that a congestion level of a cell associated with a nod exceeds a predetermined threshold. The cell may be providing communication to at least a first device having a first device type and a second device having a second device type. At block 412, concurrent with a communication of packets from the node, congestion level information for the cell is communicated to a component of a wireless communications network (e.g., core network). The congestion level information may indicate that a congestion level of the cell is above a threshold. In aspects, congestion level information may be communicated to the component of the wireless communications network by modifying a header associated with a packet to include an indication that the congestion level of the cell exceeds the predetermined threshold. Based on the indication that the congestion level of the cell exceeds the threshold, at block 414, communications may be received from the component of the wireless communications network in accordance with a modified QoS flow for the first device having a first device type but not for the second device having the second device type. Modifying the QoS flow may include decreasing a downlink speed of data sent from the core network to the node. As previously mentioned, the first device type may be any type of device, but in one aspect, is fixed wireless access.

Referring to FIG. 5, a diagram is depicted of an exemplary computing environment suitable for use in implementations of the present disclosure. In particular, the exemplary computer environment is shown and designated generally as computing device 500. Computing device 500 is but one example of a suitable computing environment and is not intended to suggest any limitation as to the scope of use or functionality of the embodiments described herein. Neither should computing device 500 be interpreted as having any dependency or requirement relating to any one or combination of components illustrated.

The implementations of the present disclosure may be described in the general context of computer code or machine-useable instructions, including computer-executable instructions such as program components, being executed by a computer or other machine, such as a personal data assistant or other handheld device. Generally, program components, including routines, programs, objects, components, data structures, and the like, refer to code that performs particular tasks or implements particular abstract data types. Implementations of the present disclosure may be practiced in a variety of system configurations, including handheld devices, consumer electronics, general-purpose computers, specialty computing devices, etc. Implementations of the present disclosure may also be practiced in distributed computing environments where tasks are performed by remote-processing devices that are linked through a communications network.

With continued reference to FIG. 5, computing device 500 includes bus 510 that directly or indirectly couples one or more of the following devices: memory 512, one or more processors 514, one or more presentation components 516, input/output (I/O) ports 518, I/O components 520, power supply 522, and radio 524. Bus 510 represents what may be one or more busses (such as an address bus, data bus, or combination thereof). The components of FIG. 5 are shown with lines for the sake of clarity. However, it should be understood that the functions performed by one or more components of the computing device 500 may be combined or distributed amongst the various components. For example, a presentation component such as a display device may be one of I/O components 520. In some embodiments, a base station, RAN and/or network server node, implementing one or more aspects of a GNAD manager may comprise a computing device 500. In some embodiments, first and second devices 102 and 104 from FIG. 1 may comprise a computing device such as computing device 500.

The processors of computing device 500, such as one or more processors 514, have memory. The present disclosure hereof recognizes that such is the nature of the art, and reiterates that FIG. 5 is merely illustrative of an exemplary computing environment that can be used in connection with one or more implementations of the present disclosure. Distinction is not made between such categories as “workstation,” “server,” “laptop,” “handheld device,” etc., as all are contemplated within the scope of FIG. 5 and refer to “computer” or “computing device.”

Computing device 500 typically includes a variety of computer-readable media. Computer-readable media can be any available non-transient media that can be accessed by computing device 500 and includes both volatile and nonvolatile media, removable and non-removable media. By way of example, and not limitation, computer-readable media may comprise computer storage media and communication media. Computer storage media includes both volatile and nonvolatile, removable and non-removable non-transient media implemented in any method or technology for storage of information such as computer-readable instructions, data structures, program modules or other data.

Computer storage media includes non-transient RAM, ROM, EEPROM, flash memory or other memory technology, CD-ROM, digital versatile disks (DVD) or other optical disk storage, magnetic cassettes, magnetic tape, magnetic disk storage or other magnetic storage devices. Computer storage media and computer-readable media do not comprise a propagated data signal or signals per se.

Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 512 includes tangible, non-transient, computer-storage media in the form of volatile and/or nonvolatile memory. Memory 512 may be removable, non-removable, or a combination thereof. Exemplary memory includes solid-state memory, hard drives, optical-disc drives, etc. Computing device 500 includes one or more processors 514 that read data from various entities such as bus 510, memory 512 or I/O components 520. One or more presentation components 516 may present data indications to a person or other device. Exemplary one or more presentation components 516 include a display device, speaker, printing component, vibrating component, etc. I/O ports 518 allow computing device 500 to be logically coupled to other devices including I/O components 520, some of which may be built in computing device 500. Illustrative I/O components 520 include a microphone, joystick, game pad, satellite dish, scanner, printer, wireless device, etc.

Radio(s) 524 represents a radio that facilitates communication with a wireless telecommunications network. For example, radio(s) 524 may be used to establish communications with a UE and/or a RAN. Illustrative wireless telecommunications technologies include CDMA, GPRS, TDMA, GSM, 4G LTE, 3GPP 5G, and other 3GPP technologies. Radio(s) 524 may additionally or alternatively facilitate other types of non-3GPP wireless communications including Wi-Fi, WiMAX, and/or other VoIP communications. In some embodiments, radio(s) 524 may support multi-modal connections that include a combination of 3GPP radio technologies (e.g., 4G, 5G and/or 6G) and/or non-3GPP radio technologies. As can be appreciated, in various embodiments, radio(s) 524 can be configured to support multiple technologies and/or multiple radios can be utilized to support multiple technologies. In some embodiments, the radio(s) 524 may support communicating with an access network comprising a terrestrial wireless communications base station and/or a space-based access network (e.g., an access network comprising a space-based wireless communications base station). A wireless telecommunications network might include an array of devices, which are not shown so as to not obscure more relevant aspects of the embodiments described herein. Components such as a base station, a communications tower, or even access points (as well as other components) can provide wireless connectivity in some embodiments.

As used herein, the terms “function”, “unit”, “server”, “node” and “module” are used to describe computer processing components and/or one or more computer executable services being executed on one or more computer processing components. In the context of this disclosure, such terms used in this manner would be understood by one skilled in the art to refer to specific network elements and not used as nonce word or intended to invoke 35 U.S.C. 112(f).

Many different arrangements of the various components depicted, as well as components not shown, are possible without departing from the scope of the claims below. Embodiments in this disclosure are described with the intent to be illustrative rather than restrictive. Alternative embodiments will become apparent to readers of this disclosure after and because of reading it. Alternative means of implementing the aforementioned can be completed without departing from the scope of the claims below. Certain features and sub-combinations are of utility and may be employed without reference to other features and sub-combinations and are contemplated within the scope of the claims.

In the preceding detailed description, reference is made to the accompanying drawings which form a part hereof wherein like numerals designate like parts throughout, and in which is shown, by way of illustration, embodiments that may be practiced. It is to be understood that other embodiments may be utilized and structural or logical changes may be made without departing from the scope of the present disclosure. Therefore, the preceding detailed description is not to be taken in the limiting sense, and the scope of embodiments is defined by the appended claims and their equivalents.

What is claimed is:

1. A system for modifying quality of service (QoS) flow for devices having particular device types based on cell congestion, the system comprising:
one or more processors; and
one or more computer-readable media storing computer-usable instructions that, when executed by the one or more processors, cause the one or more processors to:
receive congestion level information associated with a node by way of a header associated with a packet communicated from the node, the congestion level information comprising an indication that a congestion level of a cell associated with the node exceeds a predetermined threshold; and
based on the congestion level information, modify a quality of service (QoS) flow for devices of a first device type but not for devices of a second device type.

2. The system of claim 1, wherein the congestion level information comprises a percentage of congestion of the cell.

3. The system of claim 1, wherein the congestion level information comprises a 0 or a 1, indicating congestion or no congestion.

4. The system of claim 1, wherein the congestion level is at least one of throughput or load.

5. The system of claim 1, wherein the congestion level corresponds to congestion in the uplink or downlink.

6. The system of claim 1, wherein the QoS flow comprises a downlink speed of data sent from a component of a wireless communications network to the node.

7. The system of claim 1, wherein the first device type is fixed wireless access.

8. The system of claim 1, wherein modifying the QoS flow of the devices of the first device type comprises delaying the communication of acknowledgement (ACK) messages to the node.

9. The system of claim 1, wherein modifying the QoS flow of the devices of the first device type comprises queuing the communication of ACK messages to the node.

10. A method for modifying quality of service (QoS) flow for devices having particular device types based on cell congestion, the method comprising:
determining that a congestion level of a cell associated with a node exceeds a predetermined threshold, wherein the cell is providing communication to at least a first device having a first device type and a second device having a second device type;
prior to transmitting a packet to a component of a wireless communications network, modifying a header associated with the packet to include an indication that the congestion level of the cell exceeds the predetermined threshold; and
based on the indication that the congestion level of the cell exceeds the predetermined threshold, modifying a quality of service (QoS) flow for devices having the first device type but not for devices having the second device type.

11. The method of claim 10, wherein the congestion level corresponds to congestion in the uplink or downlink.

12. The method of claim 10, wherein the QoS flow comprises a downlink speed of data sent from the component of the wireless communications network to the node.

13. The method of claim 10, wherein the first device type is fixed wireless access.

14. The method of claim 10, wherein the component is part of a core network of the wireless communications network.

15. The method of claim 10, wherein the modification to the QoS flow comprises throttling fulfillment of a data request from the devices having the first device type.

16. The method of claim 15, wherein the throttling comprises queuing TCP uplink ACK messages.

17. A method for modifying quality of service (QoS) flow for devices having particular device types based on cell congestion, the method comprising:
determining that a congestion level of a cell associated with a node exceeds a predetermined threshold, wherein the cell is providing communication to at least a first device having a first device type and a second device having a second device type;
concurrent with a communication of packets from the node, communicating congestion level information for the cell to a component of a wireless communications network, the congestion level information indicating that a congestion level of the cell is above a predetermined threshold; and
based on the indication that the congestion level of the cell exceeds the predetermined threshold, receiving communications from the component of the wireless communications network in accordance with a modified quality of service (QoS) flow for the first device having the first device type but not for the second device having the second device type.

18. The method of claim 17, wherein the congestion level information is communicated to the component of the wireless communications network by modifying a header associated with the packet to include an indication that the congestion level of the cell exceeds the predetermined threshold.

19. The method of claim 17, wherein the QoS flow comprises a downlink speed of data sent from the component of the wireless communications network to the node.

20. The method of claim 17, wherein the first device type is fixed wireless access.
